(19) United States
(12) Patent Application Publication
(10) Pub. No.: US 2026/0106840 A1
(43) Pub. Date: Apr. 16, 2026

(54) CREDIT-BASED FLOW CONTROL FOR ETHERNET

(71) Applicant: Hewlett Packard Enterprise Development LP, Spring, TX (US)

(72) Inventors: David Charles Hewson, Bristol (GB); Jonathan P. Beecroft, Bristol (GB); Robert L. Alverson, Seattle, WA (US); Timothy J. Johnson, Sun Prarie, WI (US)

(21) Appl. No.: 18/913,603

(22) Filed: Oct. 11, 2024

(51) Int. Cl. H04L 47/10; H04L 45/74

(52) U.S. Cl. CPC H04L 47/39; H04L 45/74

(57) ABSTRACT

In a network, a receiver receives from a transmitter a data frame comprising a transmitter credit count which indicates a total number of credits available at the transmitter. The system determines, based on the transmitter credit counts included in the consecutively received data frames, whether one or more data frames have been lost. In response to one or more data frames being lost, the system calculates a number of credits corresponding to the lost data frames. The system then determines a number of credits to be returned to the transmitter based at least on the lost data frames and credits released by the receiver, updates a receiver credit count by incrementing an instant receiver credit count by the number of credits to be returned to the transmitter, and transmits a credit-control frame to the transmitter, the credit-control frame comprising the number of to-be-returned credits and the updated receiver credit count.

### STATEMENT OF GOVERNMENT-FUNDED RESEARCH

This invention was made with Government support under Contract Number H98230-23-C-0350 awarded by the Maryland Procurement Office. The Government has certain rights in this invention.

### BACKGROUND

### Field

This disclosure is generally related to credit-based flow control in a network. More specifically, this disclosure is related to implementing the credit-based flow control in Ethernet.

### Related Art

As data speed increases on Ethernet links, larger buffers are needed to support priority-based flow control (PFC). Credit-based flow control has been used to manage buffer spaces in various proprietary protocols. It is desirable to extend the credit-based flow control to Ethernet links. However, credit-based flow control often requires an accurate count of credits (e.g., via the exchange of credit-control frames), whereas Ethernet links are fundamentally lossy, which affects the efficacy of the flow-control mechanism.

### BRIEF DESCRIPTION OF THE FIGURES

FIG. 1A illustrates an example Ethernet data frame embedded with credit-control information, according to one aspect of the instant application.

FIG. 1B illustrates an example Ethernet data frame embedded with credit-control information, according to one aspect of the instant application.

FIG. 2 illustrates an example credit-control frame, according to one aspect of the instant application.

FIG. 3 illustrates an example process for tracking credits to facilitate credit-based flow control on an Ethernet link, according to one aspect of the instant application.

FIG. 4 presents a flowchart illustrating an example process for updating the receiver credit count, according to one aspect of the instant application.

FIG. 5 presents a flowchart illustrating an example process for updating the transmitter credit count, according to one aspect of the instant application.

FIG. 6 illustrates an example functional block diagram of a network device, according to one aspect of the instant application.

FIG. 7 illustrates a computer-readable medium that facilitates tracking the receiver credit count, according to one aspect of the instant application.

In the figures, like reference numerals refer to the same figure elements.

### DETAILED DESCRIPTION

Priority-based Flow Control (PFC) has been used to manage network traffic and prevent congestion in data center networks. PFC uses a mechanism called “pause frames” to control traffic flow. When congestion occurs, a network device (e.g., a switch or router) with PFC capabilities may issue a pause frame to temporarily halt transmission for a particular priority level while allowing other priority levels to continue flowing, thus preventing frame loss for high-priority traffic.

PFC relies on thresholds to determine when to send pause frames. For example, when buffer usage reaches the “Xoff” threshold, a pause frame is sent to stop the incoming traffic, and when buffer usage drops below the “Xon” threshold, an un-pause frame is sent to resume traffic flow. A skid space (or skid buffer) is required to account for the latency between the buffer and the sending device. Higher link speeds often require a larger skid space. Moreover, for PFC, the skid space is required for each of the eight Priority Code Points (PCPs) to prevent head-of-line blocking between traffic classes. The cumulative skid space requirements may consume significant chip area on an Ethernet device.

Considering that the skid space is rarely fully utilized, in some aspects of this disclosure, instead of using separate skid buffers for different traffic classes, a shared skid buffer may be used. In further aspects, this shared skid buffer may be managed using a credit-based flow-control mechanism to provide guaranteed buffer space for each traffic class.

Credit-based flow control has emerged as a buffer management technique in various proprietary network protocols. In credit-based systems, a sender consumes credits when sending data frames to a receiver, and the receiver returns credits to the sender after the data frame is removed from its buffer. This allows the sender to manage the buffer space in a sophisticated manner, balancing the buffering and bandwidth requirements across different traffic classes. However, the effectiveness of the credit-based flow-control system relies on the accurate count of credits, making it a complex problem to adapt such a mechanism to Ethernet's existing protocols and infrastructure because Ethernet is inherently lossy. More specifically, during data transmission over Ethernet networks, packets can sometimes be lost, dropped, or corrupted due to various factors, thus making it difficult to have accurate counts of credits consumed by the transmitter and credits returned by the receiver. Combining PFC and credit-based flow control presents a challenge.

To overcome such a challenge, in some aspects, the transmitter and receiver may track the available and returned credits, respectively, and exchange credit-count information to identify and account for credits lost on the wire. In one example, the credits may be managed on each end as a rolling count, where the transmitter decreases a transmitter credit count each time a data frame is transmitted (hence credits are consumed) to track the number of credits available on the transmitter, and the receiver increases a receiver credit count each time credits are returned to the transmitter. In some aspects, the credits may be tracked for each traffic class. Depending on the implementation, each credit may correspond to a predetermined data amount (e.g., 32 bytes, 664 bytes, 128 bytes, etc.).

When transmitting a data frame, the transmitter may include, in the transmitted data frame, the current count of credits available on the transmitter. The receiver may compare the transmitter credit counts in consecutively received data frames to determine whether one or more data frames (thus credits) have been lost during transmission. More specifically, the receiver may determine that one or more data frames are lost if the difference between the transmitter credit counts included in the consecutively received data frames is greater than the size (which is measured in credits) of the received data frame. For example, a newly received data frame with a size of l credits may indicate that the transmitter credit count at the time of the data frame transmission is m, and a previously received data frame may indicate that the previous transmitter credit count is n. The receiver may compute n−m−l. If no data frame is lost, n−m−l=0. If the result is greater than zero, the receiver may determine that credits have been lost on the wire, and the number of lost credits is computed according to n−m−l.

In some aspects of the instant application, the transmitter credit count may be included in the preamble of an Ethernet data frame. As specified in the IEEE 802.3 standard, an Ethernet frame includes a seven-octet preamble. The preamble of a conventional Ethernet frame includes alternating ones and zeros. To extend the credit-based flow control to Ethernet, a transmitter may be configured to modify the preamble to embed the credit-count information. In one example, the transmitter may generate an Ethernet frame with an eight-octet preamble, and a predetermined number of bytes (e.g., the last four bytes) in the preamble may be used to represent the current credit count at the transmitter. Note that a transmitter may withhold transmission of data frames in a traffic class if the transmitter credit count for that traffic class is below a predetermined threshold to prevent the traffic class from occupying more buffer space than its fair share.

In some aspects, the transmitter credit count may be included in a special header (referred to as a credit-control header) inserted between standard Ethernet header fields and the Ethernet payload in a way similar to the application of the 802.1Q headers (i.e., the virtual local area network (VLAN) tags). The EtherType field in the Ethernet header may be used to indicate the existence of the credit-control header. In some examples, the credit-control header may include eight octets. When the credit count is inserted between the Ethernet header and payload, it may be protected by the Ethernet Frame Checksum (FCS) at the end of the Ethernet frame. When the credit count is included in the preamble, it may be protected by the error correction code (ECC) as part of the forward error correction (FEC) scheme implemented in high-speed Ethernet links.

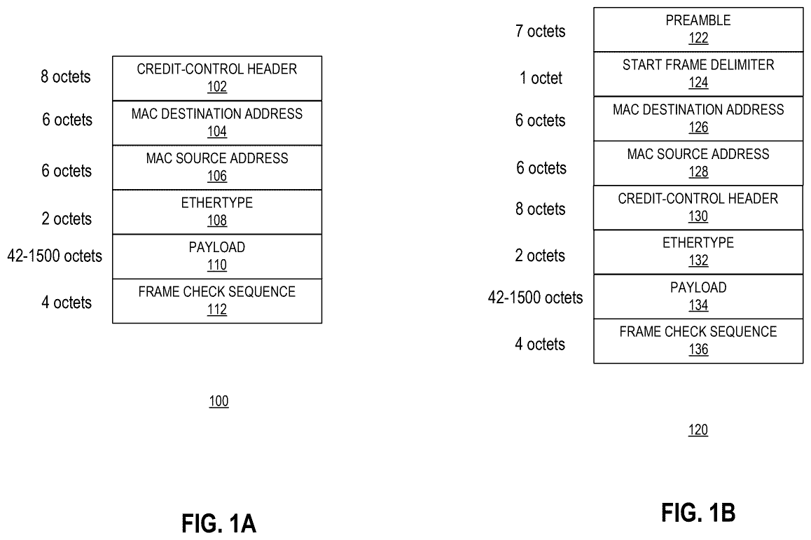

FIG. 1A illustrates an example Ethernet data frame embedded with credit-control information, according to one aspect of the instant application. In FIG. 1A, Ethernet data frame 100 includes a credit-control header field 102, a medium access control (MAC) destination address field 104, a MAC source address field 106, an EtherType field 108, a payload field 110, and a frame check sequence (FCS) field 112.

Credit-control header field 102 may be 8-octet long and may include credit-count information and traffic-class information. The credit-count information may indicate a count of available credits at the transmitter at the time Ethernet frame 100 is transmitted. The traffic-class information may indicate the traffic class associated with the credit count. The transmitter keeps separate credit counts for the different traffic classes. Each traffic class may be assigned a predetermined number of credits. A higher-priority traffic class may be assigned more credits than a lower-priority traffic class. In some aspects, the system may implement dynamic buffer allocation. More specifically, the transmitter may be in control of allocating receiver buffer spaces among traffic classes. Depending on the application, the transmitter may choose to allocate all, some, or just a small amount of the receiver's available buffer space to a particular traffic class. This is possible because the transmitter has the potential benefit of knowing more about the data being sent and how much buffer space would be needed by each traffic class.

In one example, credit-control header field 102 may include the credit count for the particular traffic class to which the data frame belongs. In an alternative example, credit-control header field 102 may include credit counts for all traffic classes.

MAC destination address field 104 and MAC source address field 106 each may include six octets and may include the destination and source address of Ethernet frame 100, respectively. EtherType field 108 may include two octets and is typically used to indicate the protocol encapsulated in the payload of the frame. The length of payload field 110 may vary (e.g., between 42 and 1500 octets). FCS field 112 is a four-octet cyclic redundancy check (CRC) that allows the detection of corrupted data within the entire frame as received on the receiver side.

FIG. 1B illustrates an example Ethernet data frame embedded with credit-control information, according to one aspect of the instant application. In FIG. 1B, Ethernet data frame 120 includes a preamble field 122, a start frame delimiter (SFD) field 124, a MAC destination address field 126, a MAC source address field 128, a credit-control header field 130, an EtherType field 132, a payload field 134, and an FCS field 136.

Preamble field 122 may include seven octets of alternating ones and zeros. SFD field 124 includes one octet and ends with a one to signal the start of the actual frame. MAC destination address field 126 and MAC source address field 128 are similar to MAC destination address field 104 and MAC source address field 106, respectively.

Credit-control header field 130 is similar to credit-control header field 102 and may include credit-count information and traffic-class information. In some aspects, credit-control header field 130 may include the transmitter credit counts corresponding to one or traffic classes. EtherType field 132 may include a predetermined value to indicate to devices receiving Ethernet frame 120 the existence of credit-control header field 130 in a way similar to VLAN tagging. Payload field 134 and FCS field 136 are similar to payload field 110 and FCS field 112, respectively.

Ethernet data frames 100 and 120 are similar to standard Ethernet data frames (e.g., an Ethernet frame defined by existing IEEE 802.3 standards), except that, Ethernet data frame 100 replaces the 7-octet preamble field and the 1-octet SFD with an 8-octet credit-control header field (i.e., field 102), and Ethernet data frame 120 includes an additional 8-octet credit-control header field (i.e., field 130). A network device aware of the credit-control header field 102 or 130 may parse Ethernet data frame 100 or 120, respectively, to obtain the transmitter credit counts corresponding to one or more traffic classes, whereas a device unaware of the credit-control header may process Ethernet data frame 100 or 120 normally by ignoring the credit-control header.

Lost credits correspond to lost data frames, which do not occupy buffer space on the receiver. Accordingly, in response to determining that credits are lost on the wire, the receiver may return those credits to the transmitter. In some aspects of the instant application, a receiver may generate and send a credit-control frame to the transmitter to return credits. In further aspects, in addition to specifying the number of to-be-returned credits, the credit-control frame may include the receiver credit count for one or more traffic classes. In one example, responsive to determining that a data frame of a particular traffic class is lost during transmission, the receiver may generate and send a credit-control frame to the transmitter to return a number of credits corresponding to the lost data frame. The credit-control frame may specify the number of to-be-returned credits. Moreover, the credit-control frame may include the current receiver credit count (i.e., the total number of returned credits) associated with the particular traffic class. In an alternative example, the credit-control frame may include the current receiver credit counts of all traffic classes.

Like data frames that may be lost on the wire, credit-control frames sent from the receiver to the transmitter may also be lost during transmission. To resolve the lost credit-control frame, in some aspects, the transmitter may compare the receiver credit counts included in consecutively received credit-control frames. For example, if the current credit-control frame returns r credits and indicates that the receiver credit count is s, and a previous credit-control frame indicates that the receiver credit count is t, then the number of returned credits lost on the wire may be computed according to s−t−r. If such a value is non-zero, the transmitter may determine that a number of credits returned by the receiver has been lost on the wire. Accordingly, the transmitter may update its available credits by adding such a number and the returned credits in the received credit-control frame. The transmitter credit count may be updated for each traffic class.

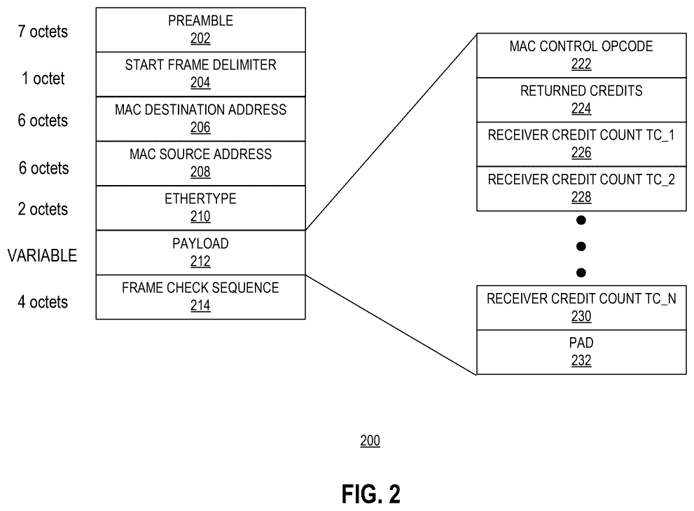

FIG. 2 illustrates an example credit-control frame, according to one aspect of the instant application. In this example, a credit-control frame 200 may be similar to an existing MAC control frame (e.g., the PAUSE frame defined by the IEEE 802.3x standard or the PFC frame defined by the IEEE 802.1Qbb standard). More specifically, credit-control frame 200 may include a preamble field 202, an SFD field 204, a MAC destination address field 206, and a MAC source address field 208, which may be similar to preamble field 122, SFD field 124, MAC destination address field 126, and MAC source address field 128, respectively.

Credit-control frame 200 may include an EtherType field 210, which may be similar to EtherType field 132. In some examples, EtherType field 210 may have a value of 0x8808, indicating that credit-control frame 200 is an Ethernet flow-control frame.

Like a MAC control frame, payload field 212 may further include a plurality of fields, such as a two-octet MAC control opcode field 222, indicating that the control frame is used for returning credits. Note that the opcode in a PAUSE frame is 0x0001, and the opcode for a PFC PAUSE is 0x0101. In this example, MAC control opcode field 222 may have a predetermined value different from the MAC control opcodes in the PAUSE frames.

Payload field 212 may include a returned credits field 224 specifying the number of credits to be returned to the transmitter. When returning credits corresponding to data frames lost on the wire, the number of to-be-returned credits specified by credit-control frame 200 may equal the sum of the lengths of all lost data frames. In addition to the number of credits, returned credits field 224 may also include traffic-class information. For example, if a lost data frame belongs to a particular traffic class, the returned credits corresponding to that lost frame also belong to that traffic class. In addition to lost data frames, the receiver may also use credit-control frame 200 to return credits to the transmitter when credits are freed (e.g., a data frame is removed from the shared buffer). In such a situation, the number of credits specified by returned credits field 224 may also include credits corresponding to the size of the removed data frame, and returned credits field 224 may further include traffic-class information corresponding to the removed data frame. When frames belonging to different traffic classes are removed, returned-credits field 224 may include the credit and traffic-class information corresponding to each traffic class.

In the example shown in FIG. 2, payload field 212 may include a plurality of receiver credit count fields, one for each traffic class (TC), such as receiver credit count TC_1 field 226, receiver credit count TC_2 field 228, and receiver credit count TC_N field 230. In this example, the receiver credit counts for all traffic classes are included in credit-control frame 200. In alternative examples, payload field 212 may only include the receiver credit counts for traffic classes with changing values. For example, if the receiver credit count for a particular traffic class has been updated (e.g., because a frame of that particular traffic class exits the shared buffer) since the transmission of the last credit-control frame, payload field 212 may include the updated receiver credit count for that particular traffic class. On the other hand, if the receiver credit count for a particular traffic class has remained the same, such information will not be included in payload field 212.

Payload field 212 may also include a PAD field 232 for padding the frame with zeros. Credit-control frame 200 may also include FCS field 214 that is similar to FCS field 136. In addition to using the MAC control frame, according to alternative aspects, the credit-control frame may also use a different encoding of the Ethernet preamble to include information associated with the returned credits and the receiver credit counts. Such credit-control frames may have a format similar to Ethernet frame 100.

In some aspects, the receiver does not need to return credits immediately after credits become available (e.g., due to lost data frames or frames exiting the shared buffer). The receiver may accumulate to-be-returned credits. In some examples, the receiver may generate and send the credit-control frames in response to determining that the number of accumulated to-be-returned credits exceeds a predetermined threshold to reduce bandwidth consumption and improve efficiency. In further examples, the receiver may generate and send the credit-control frames periodically. In an extreme case where no credit is available for return after a predetermined interval, the receiver may send the credit-control frames with zero to-be-returned credit along with the receiver credit counts for all traffic classes to allow the transmitter to recover from potentially lost credit-control frames. In other words, there are at least two trigger conditions for the credit-control frames: the accumulated to-be-returned credits and the maximum interval between consecutive credit-control frames. At least one credit-control frame will be generated and sent to the transmitter if any trigger condition is met.

To implement the aforementioned credit-based flow control, the Ethernet devices at the transmitter and receiver ends should be able to parse the received Ethernet data and control frames (e.g., frames 100, 120, and 200) to obtain the credit information. In some aspects, during the link negotiation process, the transmitter and receiver may determine whether its link partner supports credit-based flow control and, if so, which frame format (e.g., frame 100 or 120) is supported. In further aspects, the transmitter and receiver may exchange Link Layer Discovery Protocol (LLDP) messages. If one of the link partners does not support credit-based flow control, the traditional PFC mechanisms may be used for flow control (i.e., one buffer per traffic class). The link partners may also negotiate the size of each credit during the negotiation.

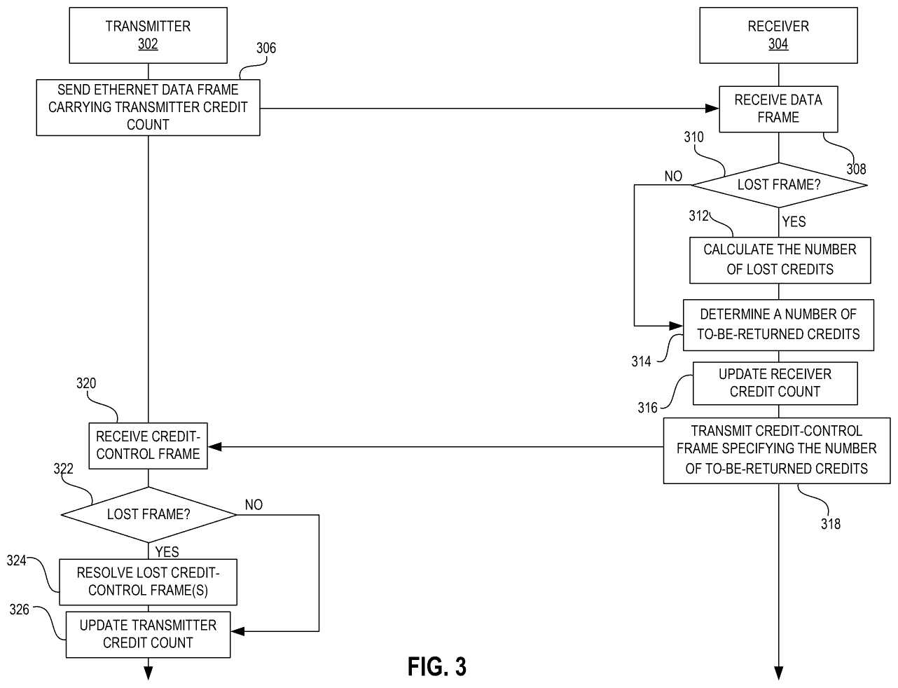

FIG. 3 illustrates an example process for tracking credits to facilitate credit-based flow control on an Ethernet link, according to one aspect of the instant application. In this example, the Ethernet link includes a transmitter 302 at one end and a receiver 304 at the other end. Note that an Ethernet node may include a transmitter and a receiver for communicating with other nodes via Ethernet links. For example, the transmitter of a local node may send data frames to a remote node, and the receiver of the local node may receive data frames from the remote node.

During operation, transmitter 302 may send an Ethernet data frame carrying the transmitter credit count to receiver 304 (operation 306). The Ethernet data frame may include a credit-control header, similar to Ethernet frame 100 or Ethernet frame 120. The transmitter credit count (i.e., the number of credits available at the transmitter) may be embedded in the credit-control header. The credit-control header may also include the traffic-class information (e.g., the priority code point (PCP) value) associated with the data frame. In one example, the credit-control header may include the credit count for the particular traffic class to which the data frame belongs. In an alternative example, the credit-control header may include credit counts for all traffic classes. Receiver 304 may receive the data frame (operation 308).

Responsive to receiving the data frame, receiver 304 may determine whether one or more data frames have been lost during transmission (operation 310). Because Ethernet does not guarantee delivery, frames may be lost on the wire. In some aspects, receiver 304 may compare the transmitter credit counts included in the newly received frame and a previously received frame to determine whether one or more data frames have been lost. More specifically, receiver 304 may determine that one or more data frames are lost if the difference between the transmitter credit counts is greater than the size of the newly received frame.

If one or more data frames have been lost, receiver 304 may calculate the number of lost credits (operation 312). In one example, the number of lost credits may be calculated by subtracting the size of the newly received frame from the difference between the transmitter credit counts.

Receiver 304 may subsequently determine the number of to-be-returned credits (operation 314) and update the receiver credit count accordingly (operation 316). More specifically, the receiver credit count may be updated by adding the to-be-returned credits to the current count. The to-be-returned credits may include credits lost on the wire and credits released by receiver 304. In this example, the credits lost on the wire correspond to the frames sent by transmitter 302 but not received by receiver 304), and the credits released by receiver 304 correspond to frames exiting the shared buffer. In certain situations, no credit is lost on the wire, and receiver 304 may only need to return the released credits. In certain situations, no data exits the shared buffer, so no credit is released, and receiver 304 may only have lost credits, if any, to return. In other situations, receiver 304 may return both the lost and released credits.

Receiver 304 may transmit a credit-control frame specifying the number of to-be-returned credits (operation 318). The credit-control frame is used to return credits to transmitter 302. In addition to the number of to-be-returned credits, the credit-control frame may include the current receiver credit count. In some examples, the credit-control frame may include the receiver credit counts for all traffic classes. In alternative examples, the credit-control frame may only include the receiver credit counts for traffic classes with updated values. In some aspects, receiver 304 may accumulate the to-be-returned credits and transmit the credit-control frame responsive to a predetermined credit or time threshold being reached. In some aspects, if no credit is to be returned, receiver 304 may periodically send a credit-control frame to transmitter 402.

Transmitter 302 receives the credit-control frame (operation 320) and determines whether one or more credit-control frames are lost during transmission (operation 322). In some aspects, transmitter 302 may compare the receiver credit counts in consecutively received credit-control frames. More specifically, transmitter 302 may compute the difference between the receiver credit counts and compare the computed difference with the returned credits specified in the received credit-control frame. Transmitter 302 may determine that one or more credit-control frames are lost on the wire if the computed difference is greater than the returned credits.

In response to determining that one or more credit-control frames are lost, transmitter 302 may resolve the lost credit control frame(s) (operation 324). More specifically, transmitter 302 may compute the number of to-be-returned credits lost on the wire by subtracting the to-be-returned credits in the received credit-control frame from the difference between the receiver credit counts in the consecutively received credit-control frames. Transmitter 302 may further compute the number of lost credits for each traffic class.

Transmitter 302 may subsequently update the transmitter credit count (operation 326). Updating the transmitter credit count may involve adding the returned credits, including those lost on the wire as determined in operation 324, to the current transmitter credit count. In some examples, transmitter 302 may update the transmitter credit count for each traffic class. Note that, although not shown in FIG. 3, before transmitter 320 and receiver 304 exchange their credit information, credits need to be synchronized on the link partners (e.g., during the link up operation). During data transmission, credits on the link partners may also be resynchronized based on the current link state.

In addition to a shared buffer, the disclosed credit-based flow control mechanism may also be used to manage other constrained resources. In some aspects, this credit-based mechanism may be used to manage a flow-tracking resource used to allocate flow channels. Examples of the flow-tracking resource may include a flow table, which may be implemented using a ternary content-addressable memory (TCAM) or other types of match functions. In some aspects, in addition to credit information associated with the receiver buffer space, the credit-control frame may include additional information, such as the load, credits regarding the flow channel acknowledgement buffer space, the link state (which may be used to bring up and take down a link in a way that synchronizes credits on link partners), a simple link message protocol, a watchdog keep alive field, error and error-checking information, etc.

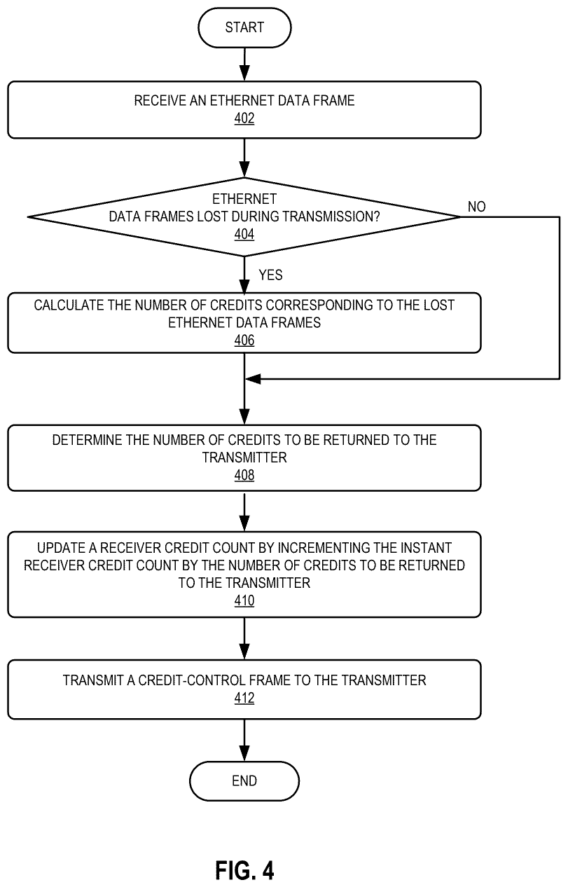

FIG. 4 presents a flowchart illustrating an example process for updating the receiver credit count, according to one aspect of the instant application. All or any portion of the operations shown in FIG. 4 may be performed, for example, by a device or set of devices implementing an Ethernet flow-control protocol (e.g., the PFC protocol). Although the example process in FIG. 4 shows a specific order of performing certain operations, the process is not limited to such an order. Operations shown in succession in the flowchart may be performed in a different order and may be executed concurrently or with partial concurrence or combinations thereof.

During operation, a receiver may receive from a transmitter an Ethernet data frame (operation 402). The Ethernet data frame may include a transmitter credit count indicating the total number of credits available at the transmitter when the Ethernet frame is transmitted. The transmitter credit count may be embedded in the preamble of the Ethernet data frame or may be included in a credit-control header inserted between the Ethernet headers and the Ethernet payload. In some examples, the data frame may include the transmitter credit count for a particular traffic class. In alternative examples, the data frame may include transmitter credit counts for all traffic classes.

Upon receiving the Ethernet data frame, the receiver may determine whether one or more Ethernet data frames have been lost during transmission based on the transmitter credit count included in the received Ethernet data frame and a transmitter credit count included in a previously received Ethernet data frame (operation 404). In some aspects, the receiver may compare the difference between the transmitter credit counts in consecutively received data frames with the number of credits corresponding to the newly received data frame. In further aspects, the credits may be counted separately for different traffic classes, and the receiver may determine the lost Ethernet frames for each traffic class.

In response to determining that one or more Ethernet data frames have been lost, the receiver may calculate a number of credits corresponding to the lost Ethernet data frames (operation 406). In some aspects, the receiver may subtract the number of credits corresponding to the newly received data frame from the difference between transmitter credit counts in consecutively received data frames. This operation may be performed for each traffic class.

The receiver may subsequently determine the number of credits to be returned to the transmitter (operation 408). The receiver may compute the number of to-be-returned credits based on the lost Ethernet data frames (if any) and Ethernet data frames exiting a shared buffer. In some aspects, the to-be-returned credits may be the sum of the credits lost on the wire and the credits released by the receiver. More specifically, the credits lost on the wire correspond to the frames sent by the transmitter but not received by the receiver, and the credits released by the receiver correspond to frames exiting the shared buffer. In certain situations, no credit is lost on the wire, and the receiver may only need to return the released credits. In certain situations, no data exits the shared buffer, so no credit is released, and the receiver may only have lost credits, if any, to return. In other situations, the receiver may return both the lost and released credits.

The receiver may then update the receiver credit count by incrementing the instant receiver credit count by the number of credits to be returned to the transmitter (operation 410). Depending on the practical scenario, the receiver may return credits to the transmitter for one or more traffic classes and then update the receiver credit count for those one or more traffic classes. If a traffic class has no lost data frame and no frame exiting the shared buffer, there is no credit to be returned to the transmitter for that traffic class.

The receiver may then transmit a credit-control frame to the transmitter (operation 412). The credit-control frame may specify the number of credits to be returned to the transmitter. In addition, the credit-control frame may include the updated receiver credit counts for one or more traffic classes. In one example, the credit-control frame may include receiver credit counts for all traffic classes. In an alternative example, the credit-control frame may only include receiver credit counts for traffic classes with updated values. In some aspects, the receiver does not return credits immediately after they are available to return. The receiver may accumulate to-bet-returned credits and return them after a predetermined credit or time threshold is reached. When there is no credit to be returned, the receiver may periodically send credit-control frames to allow the transmitter to recover lost credit-control frames.

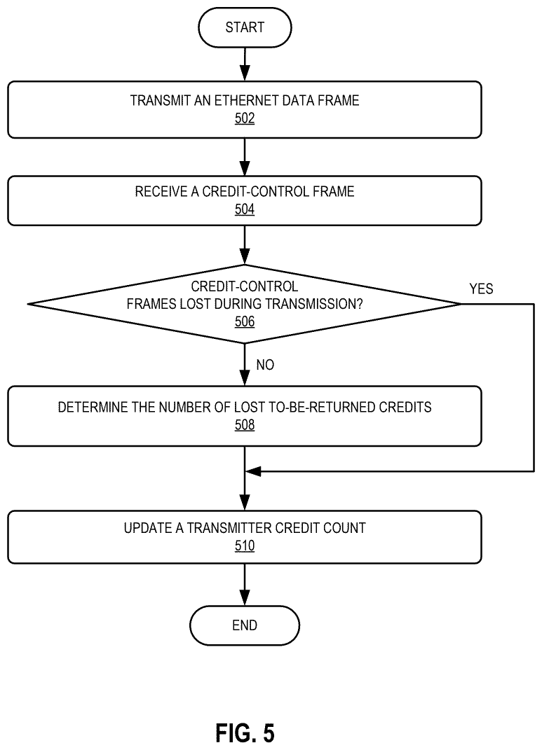

FIG. 5 presents a flowchart illustrating an example process for updating the transmitter credit count, according to one aspect of the instant application. All or any portion of the operations shown in FIG. 5 may be performed, for example, by a device or set of devices implementing an Ethernet flow-control protocol (e.g., the PFC protocol).

During operation, a transmitter may transmit an Ethernet data frame to a receiver (operation 502). The Ethernet data frame may carry the transmitter credit counts for one or more traffic classes. The transmitter may receive a credit-control frame from the receiver (operation 504). The credit-control frame specifies the number of the to-be-returned credits and the receiver credit counts for one or more traffic classes.

The transmitter may determine whether one or more credit-control frames have been lost during transmission (operation 506). In some aspects, the transmitter may compute, for each traffic class, the difference between the receiver credit counts in consecutively received credit-control frames and the to-be-returned credits. If the number of to-be-returned credits is less than the difference, one or more credit-control frames have been lost on the wire.

If one or more credit-control frames have been lost on the wire, the transmitter may further determine the number of lost to-be-returned credits (operation 508). In some examples, the transmitter may subtract the to-be-returned credits specified in the current credit-control frame from the difference between the receiver credit counts in consecutively received credit-control frames.

The transmitter may subsequently update the transmitter credit count (operation 510). If one or more lost credit-control frames have been lost, the transmitter may add the lost to-be-returned credits and the to-be-returned credits in the current control frame to the instant transmitter credit count. If no credit-control frame is lost, the transmitter may only add the to-be-returned credits in the current control frame to the instant transmitter credit count.

Although the example processes in FIGS. 3-5 show a specific order of performing certain operations, the processes are not limited to such an order. Operations shown in succession in the flowchart may be performed in a different order and may be executed concurrently or with partial concurrence or combinations thereof.

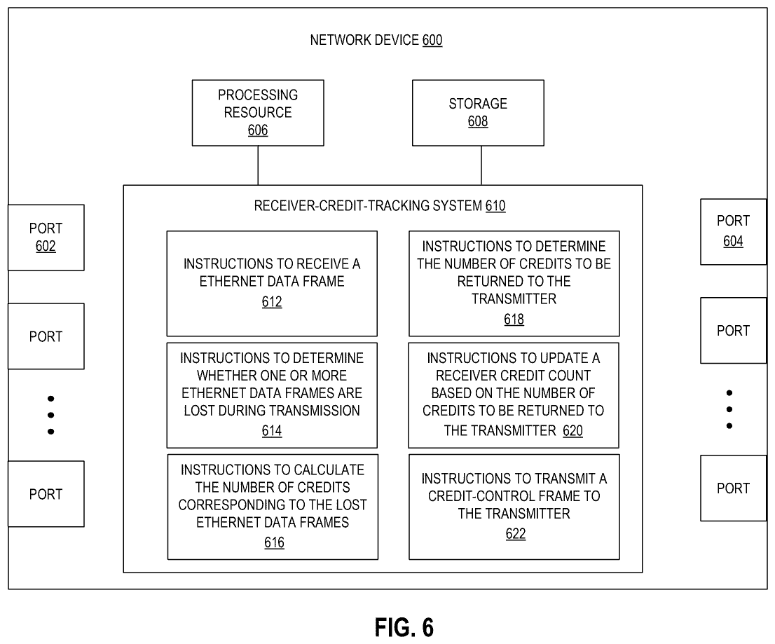

FIG. 6 illustrates an example functional block diagram of a network device, according to one aspect of the instant application. Network device 600 may include any physical devices that allow hardware on a computer network to communicate and interact with one another. Examples of network device 600 may include a switch, a router, a gateway, an access point, a network interface card (NIC), etc. In FIG. 6, network device 600 may include a number of communication ports, such as ports 602 and 604, for communicating with peer network devices. Each port may include a transmitter and a receiver.

Network device 600 may include one or more processing resources (e.g., processing resource 606), one or more storage devices (e.g., storage device 608), and a receiver-credit-tracking system 610.

In the examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media. Network device 600 may include fewer or more entities than those shown in FIG. 6.

Receiver-credit-tracking system 610 may include any number of software units, hardware units, and firmware units that work together to achieve the goal of tracking the number of credits returned from a receiver to a transmitter. In some aspects, receiver-credit-tracking system 610 may include instructions, which when executed by processing resource 606 may cause processing resource 606 to perform methods and/or processes described in this disclosure. Specifically, receiver-credit-tracking system 610 may include instructions 612 to receive an Ethernet data frame, as described above in relation to operation 308 shown in FIG. 3 and operation 402 shown in FIG. 4. In some aspects, the Ethernet data frame may include a transmitter credit count indicating the total number of credits available at the transmitter when the Ethernet frame is transmitted. In further aspects, the Ethernet data frame may include the transmitter credit counts for one or more traffic classes. Examples of the Ethernet data frame may include data frame 100 shown in FIG. 1A and data frame 120 shown in FIG. 1B.

Receiver-credit-tracking system 610 may include instructions 614 to determine whether one or more Ethernet data frames are lost during transmission, as described above in relation to operation 310 shown in FIG. 3 and operation 404 shown in FIG. 4. More specifically, instructions 614 may be used to compute the difference between transmitter credit counts included in consecutively received data frames and compare such a difference with the size of the received data frame.

Receiver-credit-tracking system 610 may include instructions 616 to calculate the number of credits corresponding to the lost (if any) Ethernet data frames, as described above in relation to operation 312 shown in FIG. 3 and operation 406 shown in FIG. 4. More specifically, instructions 616 may be used to subtract the number of credits corresponding to the received data frame from the difference between transmitter credit counts included in consecutively received data frames.

Receiver-credit-tracking system 610 may include instructions 618 to determine the number of credits to be returned to the transmitter, as described above in relation to operation 314 shown in FIG. 3 and operation 408 shown in FIG. 4. More specifically, instructions 618 may be used to determine the number of credits released by the receiver (which may correspond to Ethernet data frames exiting a shared buffer on the receiver) and then add the released credits to the lost credits.

Receiver-credit-tracking system 610 may include instructions 620 to update a receiver credit count based on the number of credits to be returned to the transmitter, as described above in relation to operation 316 shown in FIG. 3 and operation 410 shown in FIG. 4. Instructions 620 may be used to add the to-be-returned credits to the instant receiver credit count.

Receiver-credit-tracking system 610 may include instructions 622 to transmit a credit-control frame to the transmitter, as described above in relation to operation 318 shown in FIG. 3 and operation 412 shown in FIG. 4. The credit-control frame may specify the number of credits to be returned to the transmitter and their corresponding traffic classes. The credit-control frame may further include the instant receiver credit counts for one or more traffic classes, thereby facilitating the transmitter in resolving lost (if any) credit-control frames.

Network device 600 may include fewer or more entities than those shown in FIG. 6. For example, network device 600 may also include a transmitter-credit-tracking system for tracking the number of credits available at the transmitter of network device 600. Receiver-credit-tracking system 610 may include more instructions than those shown in FIG. 6. For example, receiver-credit-tracking system 610 may include instructions to accumulate to-be-returned credits before returning them and instructions to periodically send credit-control frames when there is no credit to return.

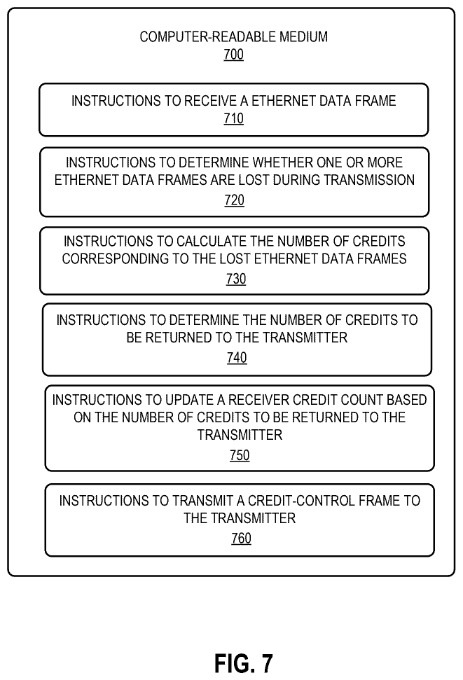

FIG. 7 illustrates a computer-readable medium that facilitates tracking the receiver credit count, according to one aspect of the instant application. CRM 700 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 700 may store instructions 710 to receive an Ethernet data frame, as described above in relation to operation 308 shown in FIG. 3 and operation 402 shown in FIG. 4; instructions 720 to determine whether one or more Ethernet data frames are lost during transmission, as described above in relation to operation 310 shown in FIG. 3 and operation 404 shown in FIG. 4; instructions 730 to calculate the number of credits corresponding to the lost (if any) Ethernet data frames, as described above in relation to operation 312 shown in FIG. 3 and operation 406 shown in FIG. 4; instructions 740 to determine the number of credits to be returned to the transmitter based at least on the lost data frames and credits released by the receiver, as described above in relation to operation 314 shown in FIG. 3 and operation 408 shown in FIG. 4; instructions 750 to update a receiver credit count based on the number of credits to-be-returned to the transmitter, as described above in relation to operation 316 shown in FIG. 3; and instructions 760 to transmit a credit-control frame to the transmitter, as described above in relation to operation 318 shown in FIG. 3 and operation 412 shown in FIG. 4.

CRM 700 may include more instructions than those shown in FIG. 7. For example, CRM 700 may include instructions to accumulate to-be-returned credits before returning them and instructions to periodically send credit-control frames when there is no credit to return.

In general, aspects of the disclosure solve the technical problem of extending the credit-based flow control to systems implementing Ethernet protocols while preserving the Ethernet frame format. To accurately track credits at both the transmitter side and the receiver side, each transmitted data frame may include the transmitter credit count information for one or more traffic classes. The transmitter credit count information may be embedded in the preamble or an additional credit-control header between the Ethernet headers and payload. The receiver may determine whether data frames (and hence credits) have been lost during transmission and return the lost credits to the transmitter. The receiver may send credit-control frames to the transmitter to return credits. Each credit-control frame may include the current receiver credit count for one or more traffic classes to facilitate the transmitter in resolving lost credit-control frames. The receiver may be configured to aggregate the credit-control frames (e.g., by accumulating the to-be-returned credits before returning). The receiver may be configured to send the credit-control frame if the interval between consecutive credit-control frames reaches a predetermined threshold. The receiver may also be configured to send the credit-control frame to the transmitter periodically when no credit is available for return to allow the transmitter to recover returned credits lost on the wire.

One aspect of the instant application provides a system and method for implementing credit-based flow control. During operation, a receiver receives from a transmitter a data frame, the data frame comprising a transmitter credit count indicating a total number of credits available at the transmitter when the data frame is transmitted. The system determines, based on the transmitter credit count included in the received data frame and a transmitter credit count included in a previously received data frame, whether one or more data frames have been lost during transmission. In response to determining that one or more data frames have been lost, the system calculates a number of credits corresponding to the lost data frames. The system then determines a number of credits to be returned to the transmitter based at least on the lost data frames and credits released by the receiver, updates a receiver credit count by incrementing an instant receiver credit count by the number of credits to be returned to the transmitter, and transmits a credit-control frame to the transmitter, the credit-control frame comprising the number of to-be-returned credits and the updated receiver credit count.

In a variation on this aspect, the transmitter receives the credit-control frame and updates the transmitter credit count based at least on the number of to-be-returned credits.

In a variation on this aspect, the system accumulates to-be-returned credits. In response to the accumulated to-be-returned credits exceeding a predetermined threshold, the system transmits the credit-control frame.

In a variation on this aspect, in response to determining that no credit is to be returned to the transmitter for a predetermined interval, the system transmits a credit-control frame to the transmitter, the credit-control frame comprising the instant receiver credit count.

In a variation on this aspect, the transmitter credit count is included in a preamble of the data frame or a credit-control header positioned between a plurality of header fields and a payload in the data frame.

In a variation on this aspect, the data frame comprises an Ethernet data frame, and the credit-control frame comprises an Ethernet media access control (MAC) control frame with a predetermined MAC control opcode.

In a variation on this aspect, the transmitter and receiver credit counts are traffic-class specific, and the credit-control frame comprises the updated receiver credit count for one or more traffic classes.

In a variation on this aspect, the credits are used to manage a buffer space or a flow-tracking resource on the receiver.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method for implementing credit-based flow control, the method comprising:
receiving, at a receiver from a transmitter, a data frame, the data frame comprising a transmitter credit count indicating a total number of credits available at the transmitter when the data frame is transmitted;
determining, based on the transmitter credit count included in the received data frame and a transmitter credit count included in a previously received data frame, whether one or more data frames have been lost during transmission;
in response to determining that one or more data frames have been lost, calculating a number of credits corresponding to the lost data frames;
determining a number of credits to be returned to the transmitter based at least on the lost data frames and credits released by the receiver;
updating a receiver credit count by incrementing an instant receiver credit count by the number of credits to be returned to the transmitter; and
transmitting a credit-control frame to the transmitter, the credit-control frame comprising the number of to-be-returned credits and the updated receiver credit count

2. The method of claim 1, further comprising:
receiving, at the transmitter, the credit-control frame; and
updating the transmitter credit count based at least on the number of to-be-returned credits.

3. The method of claim 1, further comprising:
accumulating to-be-returned credits; and
in response to the accumulated to-be-returned credits exceeding a predetermined threshold, transmitting the credit-control frame.

4. The method of claim 1, further comprising:
in response to determining that no credit is to be returned to the transmitter for a predetermined interval, transmitting a credit-control frame to the transmitter, the credit-control frame comprising the instant receiver credit count.

5. The method of claim 1, wherein the transmitter credit count is included in a preamble of the data frame or a credit-control header positioned between a plurality of header fields and a payload in the data frame.

6. The method of claim 1, wherein the data frame comprises an Ethernet data frame, and wherein the credit-control frame comprises an Ethernet media access control (MAC) control frame with a predetermined MAC control opcode.

7. The method of claim 1, wherein the transmitter and receiver credit counts are traffic-class specific, and wherein the credit-control frame comprises the updated receiver credit count for one or more traffic classes.

8. The method of claim 1, wherein the credits are used to manage a buffer space or a flow-tracking resource on the receiver.

9. The method of claim 1, wherein the credit-control frame comprises state information associated with a link between the transmitter and the receiver to facilitate synchronization of credit counts on the transmitter and receiver.

10. A network device, comprising:
a processing resource; and
a non-transitory machine-readable storage medium comprising instructions executable by the processing resource to:
receive, at a receiver from a transmitter, a data frame, the data frame comprising a transmitter credit count indicating a total number of credits available at the transmitter when the data frame is transmitted;
determine, based on the transmitter credit count included in the received data frame and a transmitter credit count included in a previously received data frame, whether one or more data frames have been lost during transmission;
in response to determining that one or more data frames have been lost, calculate a number of credits corresponding to the lost data frames;
determine a number of credits to be returned to the transmitter based at least on the lost data frames and credits released by the receiver;
update a receiver credit count by incrementing an instant receiver credit count by the number of credits to be returned to the transmitter; and
transmit a credit-control frame to the transmitter, the credit-control frame comprising the number of to-be-returned credits and the updated receiver credit count.

11. The network device of claim 10, the instructions further to:
accumulate to-be-returned credits; and
in response to the accumulated to-be-returned credits exceeding a predetermined threshold, transmit the credit-control frame.

12. The network device of claim 10, the instructions further to:
in response to determining that no credit is to be returned to the transmitter for a predetermined interval, transmitting a credit-control frame to the transmitter, the credit-control frame comprising the instant receiver credit count.

13. The network device of claim 10, wherein the data frame comprises an Ethernet data frame, wherein the transmitter credit count is included in a preamble of the Ethernet data frame or a credit-control header positioned between a plurality of header fields and a payload in the Ethernet data frame, and wherein the credit-control frame comprises an Ethernet media access control (MAC) control frame with a predetermined MAC control opcode.

14. The network device of claim 10, wherein the transmitter and receiver credit counts are traffic-class specific, and wherein the credit-control frame comprises the updated receiver credit count for one or more traffic classes.

15. The network device of claim 10, wherein the credits are used to manage a buffer space or a flow-tracking resource on the receiver.

16. A non-transitory computer-readable storage medium storing instructions to:
receive, at a receiver from a transmitter, a data frame, the data frame comprising a transmitter credit count indicating a total number of credits available at the transmitter when the data frame is transmitted;
determine, based on the transmitter credit count included in the received data frame and a transmitter credit count included in a previously received data frame, whether one or more data frames have been lost during transmission;
in response to determining that one or more data frames have been lost, calculate a number of credits corresponding to the lost data frames;
determine a number of credits to be returned to the transmitter based at least on the lost data frames and credits released by the receiver;
update a receiver credit count by incrementing an instant receiver credit count by the number of credits to be returned to the transmitter; and
transmit a credit-control frame to the transmitter, the credit-control frame comprising the number of to-be-returned credits and the updated receiver credit count.

17. The non-transitory machine-readable storage medium of claim 16, the instructions further to:
accumulate to-be-returned credits; and
in response to the accumulated to-be-returned credits exceeding a predetermined threshold, transmit the credit-control frame.

18. The non-transitory machine-readable storage medium of claim 16, the instructions further to:
in response to determining that no credit is to be returned to the transmitter for a predetermined interval, transmitting a credit-control frame to the transmitter, the credit-control frame comprising the instant receiver credit count.

19. The non-transitory machine-readable storage medium of claim 16,
wherein the data frame comprises an Ethernet data frame;
wherein the transmitter credit count is included in a preamble of the Ethernet data frame or a credit-control header positioned between a plurality of header fields and a payload in the Ethernet data frame; and
wherein the credit-control frame comprises an Ethernet media access control (MAC) control frame with a predetermined MAC control opcode.

20. The non-transitory machine-readable storage medium of claim 16, wherein the transmitter and receiver credit counts are traffic-class specific, and wherein the credit-control frame comprises the updated receiver credit count for one or more traffic classes.
